(19) United States
(12) Patent Application Publication
(10) Pub. No.: US 2018/0335270 A1
(43) Pub. Date: Nov. 22, 2018

(54) BOW/GUN HOLDER WITH HOOKS

(71) Applicant: Douglas Smith, Groton, NY (US)

(72) Inventor: Douglas Smith, Groton, NY (US)

(21) Appl. No.: 15/986,775

(22) Filed: May 22, 2018

Related U.S. Application Data
(60) Provisional application No. 62/509,322, filed on May 22, 2017.

(51) Int. Cl. F41B 5/14; A01M 31/00; F16M 13/02; F41A 23/18

(52) U.S. Cl. CPC F41B 5/1453; F41A 23/18; F16M 13/02; A01M 31/00

(57) ABSTRACT

A bow/gun holder that includes: a horizontal portion wherein the horizontal portion includes a proximal and a distal end; a bow extension wherein the bow extension includes a proximal and a distal end; a connector where the connector connects the horizontal portion to the bow extension; and a series of hooks on the horizontal and bow extension portions of a gun holder; and a brace to support extending from the horizontal portion.

### CROSS REFERENCE TO OTHER APPLICATIONS

This application claims priority to U.S. Provisional Application Ser. No. 62/509,322 filed on May 22, 2017.

### BACKGROUND OF THE INVENTION

### Field of the Invention

This invention relates generally to an accessory for hunters to fasten their hunting equipment and gear all in one place.

### Description of the Prior Art

The Bow/Gun Holder with Hooks is a primary holder that gives hunters an accessory to fasten their hunting equipment and gear all in one place. Hunting is an age-old sport that has been defined in the 21st century with innovations in hunting bows, rifles, and gear. However, ease of access to the equipment when stalking the prey or preparing to camp and being ready for situations remains hindered; which makes choosing the right equipment quite difficult for successful hunting sessions. The Bow/Gun Holder with Hooks is a multi-purpose arsenal holder that can be screwed-in to trees on one end and carry bows and/or guns on the other. The Bow/Gun Holder features two high-grade metal rods, one with the holder attached and the other with a metal screw for trees along with an opening for clamps. The adjustable clamps can hook various items such as binoculars, grant tube, hunting calls, range finder, water bottles,

The Bow/Gun Holder with Hooks is a unique entry in the accessory market for bow hunters. The Bow/Gun Holder with Hooks provides consumers with a convenient holder that also provides a quick and easy way to fasten the essential hunting gear to allow users to never miss an opportunity in the wild

### SUMMARY OF THE INVENTION

A bow/gun holder that includes: a horizontal portion wherein the horizontal portion includes a proximal and a distal end; a bow extension wherein the bow extension includes a proximal and a distal end; a connector where the connector connects the horizontal portion to the bow extension; and a series of hooks on the horizontal and bow extension portions of a gun holder; and a brace to support extending from the horizontal portion.

### BRIEF DESCRIPTION OF THE DRAWINGS

FIG. 1 illustrates a front view of a bow/gun holder with hooks, in accordance with the present invention.

### DETAILED DESCRIPTION OF THE INVENTION

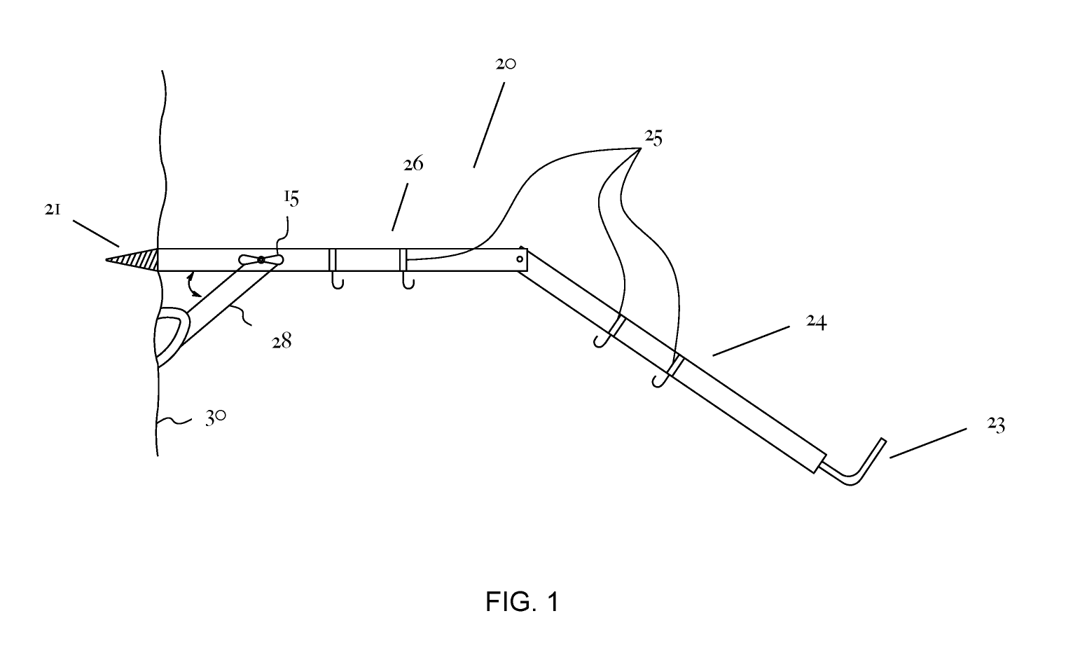

A bow/gun holder 20 is shown in FIG. 1. The bow/gun holder includes a horizontal portion 26 and an bow extension 24. The bow/gun Holder 20 further includes a threaded screw at the proximal end thereof. Screw 21 is shown in FIG. 1 engaged into a tree 30. Extending from a horizontal Portion 26 is a Brace 28 attached thereto with a butterfly nut 15. This provides a anchoring system to anchor the horizontal Portion 26 in a stationary position. During use a hunter may hang objects by the Hooks 25 along the horizontal Portion 26 or the bow Extension 24. At the distal end thereof is a bow Holder 23 specifically a bow holder 23 is provided to support a hunting bow. Once this device is in place a hunter may use then easily place equipment in this position for easy access to while hunting. Due to the firm mounting provided a screw Thread 21 and mounting Brace 28 the bow/gun Holder 20 is able to support a substantial amount of weight associated with the hunter's equipment.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A bow/gun holder comprising:
a horizontal portion wherein the horizontal portion includes a proximal and a distal end;
a bow extension wherein the bow extension includes a proximal and a distal end;
a connector where the connector connects the horizontal portion to the bow extension; and
a series of hooks on the horizontal and bow extension portions of a gun holder; and
a brace to support extending from the horizontal portion.

2. The bow holder according to claim 1 further including a butterfly bolt is attaches the brace to the horizontal portion.

3. The bow/gun holder according to claim 1 further including a bow holder at the distal end on the bow extension.

4. The bow gun holder according to claim 1 wherein the equal number of hooks are on the horizontal portion as to the bow extensions.
